(19) United States
(12) Patent Application Publication
(10) Pub. No.: US 2016/0181021 A1
(43) Pub. Date: Jun. 23, 2016

(54) SOLID ELECTROLYTE CAPACITOR AND MANUFACTURING METHOD THEREOF

(71) Applicant: SAMSUNG ELECTRO-MECHANICS CO., LTD., Suwon-Si (KR)

(72) Inventors: Sung Ho KWAK, Suwon-Si (KR); Hee Sung CHOI, Suwon-Si (KR)

(21) Appl. No.: 14/871,437

(22) Filed: Sep. 30, 2015

(30) Foreign Application Priority Data
Dec. 18, 2014 (KR) 10-2014-0183257

(51) Int. Cl. H01G 9/052; H01G 9/00; H01G 9/048; H01G 9/032; H01G 9/012

(52) U.S. Cl. CPC H01G 9/0525; H01G 9/032; H01G 9/012; H01G 9/048; H01G 9/0029; H01G 9/0036

(57) ABSTRACT

A solid electrolyte capacitor includes a sintered body that is provided by sintering a molded body containing a mixture of metal powder and an inorganic additive. An anode lead wire is disposed to be partially inserted into the sintered body. The sintered body includes an air gap provided where the inorganic additive is removed after sintering of the molded body. A method of manufacturing the solid electrolyte capacitor is also provided.

### CROSS-REFERENCE TO RELATED APPLICATION

This application claims the priority and benefit of Korean Patent Application No. 10-2014-0183257, filed on Dec. 18, 2014, with the Korean Intellectual Property Office, the disclosure of which is incorporated herein by reference.

### BACKGROUND

The present disclosure relates to a solid electrolyte capacitor and a manufacturing method thereof.

Tantalum (Ta) is a metal that is widely used in industries such as the aerospace industry and the defense industry, as well as in the mechanical engineering industry, the chemical industry, the medical industry, the electrical products industry and the electronics industry, due to having excellent mechanical and physical properties such as a high melting point, excellent ductility and corrosion-resistant properties.

In particular, among a wide variety of metals, tantalum can form a relatively more stable anode oxide film, and thus has been widely used as an anode material for a small-sized capacitor.

Moreover, recently, the worldwide use of tantalum has sharply increased by approximately 10% every year due to the rapid development of information technology (IT) industries such as the electronics industry and the information communications industry.

A tantalum capacitor has a structure in which a gap generated when a tantalum powder is sintered and coagulated is utilized. Tantalum oxide (Ta₂O₅) may be formed on a surface of tantalum as an electrode metal through an anodizing method. The formed tantalum oxide is used as a dielectric material, on which a manganese oxide (MnO₂) layer may be formed as an electrolyte.

In addition, due to the lead-out of a cathode, a graphite layer and a metal layer formed of silver (Ag) may be formed on the MnO₂ layer.

Recently, in accordance with the development of small-sized, high capacitance products, nanoparticles have been used to manufacture tantalum devices, and thus impregnation properties of a porous body have been deteriorated. The impregnation property may reflect the amount of fluid (such as capacitor oil) that the capacitor can be impregnated with so as to increase the capacity/capacitance of the capacitor.

That is, using tantalum nanoparticles as tantalum powder may secure high specific surface area to implement high capacitance with a small sized capacitor. However, in a case in which tantalum nanoparticles are used, impregnation properties of a manganese nitrate aqueous solution or a conductive polymer solution used as a cathode layer may be deteriorated.

Therefore, it may be difficult to implement high capacitance of a product and ensure low equivalent series resistance (ESR)

### SUMMARY

An exemplary embodiment in the present disclosure may provide a solid electrolyte capacitor capable of having high capacitance and excellent equivalent series resistance (ESR) characteristics by containing a sintered body having excellent impregnation properties.

According to an exemplary embodiment in the present disclosure, a solid electrolyte capacitor may include a sintered body and an anode lead wire. The sintered body includes a molded body containing a mixture of metal powder and an inorganic additive.

The anode lead wire is disposed to be partially inserted into the sintered body. The sintered body includes an air gap where at least a portion of the inorganic additive is removed.

According to an exemplary embodiment in the present disclosure, a method of manufacturing a solid electrolyte capacitor may include forming a molded body by stirring metal powder and an inorganic additive and molding the same. A compressed body is formed by compressing the molded body. A sintered body is formed by sintering the compressed body. An air gap is formed by removing the inorganic additive from the sintered body after sintering.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a cross-sectional view of a molded body which is formed as part of manufacturing a solid electrolyte capacitor according to an exemplary embodiment in the present disclosure;

FIG. 2 is a cross-sectional view of a compressed body which is formed as part of manufacturing the solid electrolyte capacitor according to the exemplary embodiment in the present disclosure;

FIG. 3 is a cross-sectional view of a sintered body which is formed as part of manufacturing the solid electrolyte capacitor according to the exemplary embodiment in the present disclosure;

FIG. 4 is a perspective view of a solid electrolyte capacitor according to an exemplary embodiment in the present disclosure;

FIG. 5 is a cross-sectional view of the solid electrolyte capacitor taken along line A-A′ of FIG. 4; and

FIG. 6 is a cross-sectional view of a solid electrolyte capacitor according to another exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

### Solid Electrolyte Capacitor

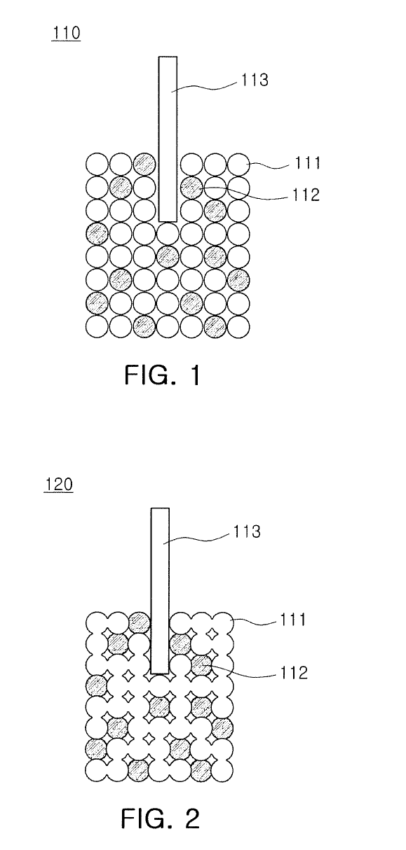

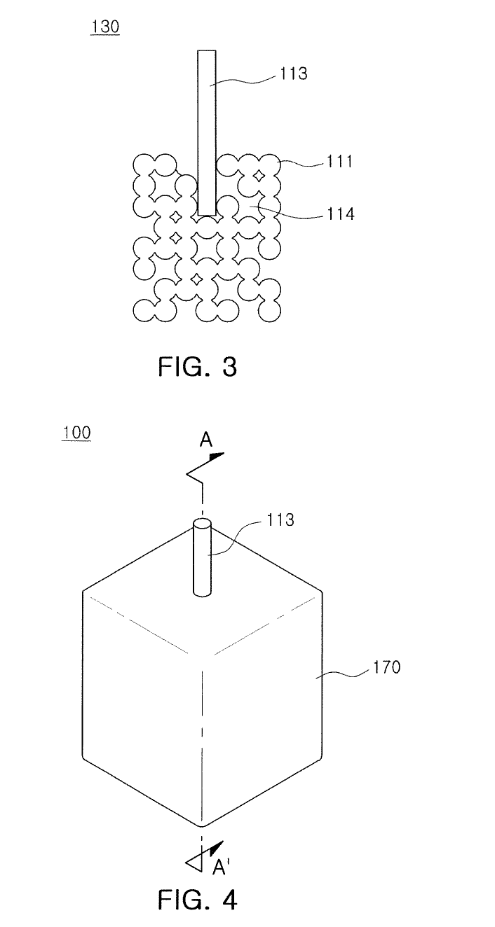

FIG. 1 is a cross-sectional view of a molded body 110 which is formed in order to manufacture a solid electrolyte capacitor 100 according to an exemplary embodiment, FIG. 2 is a cross-sectional view of a compressed body 120 which is formed in order to manufacture the solid electrolyte capacitor 100 according to the exemplary embodiment, and FIG. 3 is a cross-sectional view of a sintered body 130 which is formed in order to manufacture the solid electrolyte capacitor 100 according to the exemplary embodiment.

Referring to FIGS. 1 through 3, the solid electrolyte capacitor 100, according to the exemplary embodiment, may include the sintered body 130 formed by sintering a molded body containing a mixture of metal powder 111 and an inorganic additive 112 and an anode lead wire 113 disposed to be partially inserted into the sintered body 130, wherein the sintered body 130 may include air gaps 114 formed by removing the inorganic additive 112 after sintering.

The sintered body 130 may be formed by compressing and sintering the molded body 110 containing the metal powder 111 and the inorganic additive 112.

In detail, the molded body 110 may be formed by stirring the metal powder 111 and the inorganic additive 112 at a predetermined ratio and molding the mixture of the metal powder 111 and the inorganic additive 112 mixed by the stirring in a rectangular parallelepiped shape, as shown in FIG. 1. Thereafter, after compressing the molded body 110 to form the compressed body 120 of FIG. 2, the sintered body 130 may be manufactured by sintering the compressed body under high temperature and vibration conditions.

The metal powder 111 is not particularly limited as long as it maybe used in the sintered body 130 of the solid electrolyte capacitor 100. For example, the metal powder 111 may include at least one selected from the group consisting of tantalum (Ta), aluminum (Al), niobium (Nb), vanadium (V), titanium (Ti), and zirconium (Zr). Particularly, the sintered body 130 of the solid electrolyte capacitor 100, according to the exemplary embodiment, may be formed using tantalum (Ta) powder.

The molded body 110 of the solid electrolyte capacitor 100, according to the exemplary embodiment, may contain the metal powder 111 and the inorganic additive 112 in a predetermined ratio. The inorganic additive 112 is not particularly limited as long as it may be selectively removed with respect to the metal powder 111 by a solvent after the forming of the sintered body 130. In some embodiments, the molded body 110 may contain substantially only the metal powder 111 and the inorganic additive 112 without any other powders, particles, or additives.

The inorganic additive 112 used in the solid electrolyte capacitor 100, according to the exemplary embodiment, maybe silica powder. It is easy to selectively remove the silica powder with respect to the metal powder 111, and the silica powder is not decomposed or evaporated at the time of compressing and sintering due to high hardness thereof, and thus it may be easy to adjust porosity. Further, the silica powder is chemically stable, the stability thereof may be high while being processed, and mixing properties thereof may be excellent when the silica powder is stirred with the metal powder 111, and thus the silica powder and the metal powder 111 may be uniformly stirred.

A particle size of the inorganic additive 112 may be 1 μm to 10 μm. When the particle size of the inorganic additive 112 is less than 1 μm, a size of the air gaps 114 formed in the sintered body 130 may be decreased, and this improvement of impregnation properties of the solid electrolyte capacitor 100 manufactured to include the sintered body 130 may be insufficient. Further, when the particle size of the inorganic additive 112 is more than 10 μm, the size of the air gaps 114 may be increased, and thus it may be difficult to secure capacitance of the solid electrolyte capacitor 100.

In other words, a volume of the inorganic additive 112 present in the compressed body 120 formed by compressing the molded body 110 may correspond to a volume of the air gaps 114 in the sintered body 130 formed by sintering the compressed body 120. Therefore, in order to improve the impregnation properties of the solid electrolyte capacitor 100 manufactured using the sintered body 130 and secure sufficient capacitance, the particle size of the inorganic additive 112 may be selected to be within the range of 1 μm to 10 μm.

The sintered body 130 included in the solid electrolyte capacitor 100, according to the exemplary embodiment, may include the air gaps 114. As described above, the air gaps 114 may exist in the sintered body 130 and be formed by removing the inorganic additive 112 existing in the sintered body 130. Therefore, a shape of the air gaps 114 may correspond to a shape of the inorganic additive 112 removed from the sintered body 130. An example of the air gaps 114 is illustrated in FIG. 3, but the shape of the air gaps 114 is not limited to a spherical shape. That is, the shape of the air gaps 114 may vary. For example, the air gaps may have a furrow shape, a groove shape, a depression shape, an indentation shape, or the like.

In general, using tantalum nanoparticles as tantalum powder in a solid electrolyte capacitor provides a high specific surface area and high capacitance while having a small size. However, when tantalum nanoparticles are used, impregnation properties of a manganese nitrate aqueous solution or a conductive polymer solution used as a cathode layer may be deteriorated. Therefore, it may be difficult to obtain a product having high capacitance and low equivalent series resistance (ESR).

Since the solid electrolyte capacitor 100, according to the exemplary embodiment, includes the sintered body 130 having air gaps 114 formed by removing the inorganic additive 112, impregnation properties may be improved, and high capacitance and excellent equivalent series resistance (ESR) characteristics may nonetheless be implemented.

The solid electrolyte capacitor 100, according to the exemplary embodiment, may additionally include the anode lead wire 113 disposed to be partially inserted into the sintered body 130.

The anode lead wire 113 may contain a tantalum ingredient and be partially inserted into the sintered body 130 of the solid electrolyte capacitor 200 to thereby be connected to external power via an anode lead frame 210 (see FIG. 6), thereby forming an anode.

As illustrated in FIG. 3, the anode lead wire 113 may be disposed in such a manner that it is led from or extends from one surface of the sintered body 130 of the solid electrolyte capacitor 100. Alternatively, the anode lead wire 113 may be led from or extend from a central portion of the sintered body 130 or may be disposed to be offset from the central portion of the sintered body 130.

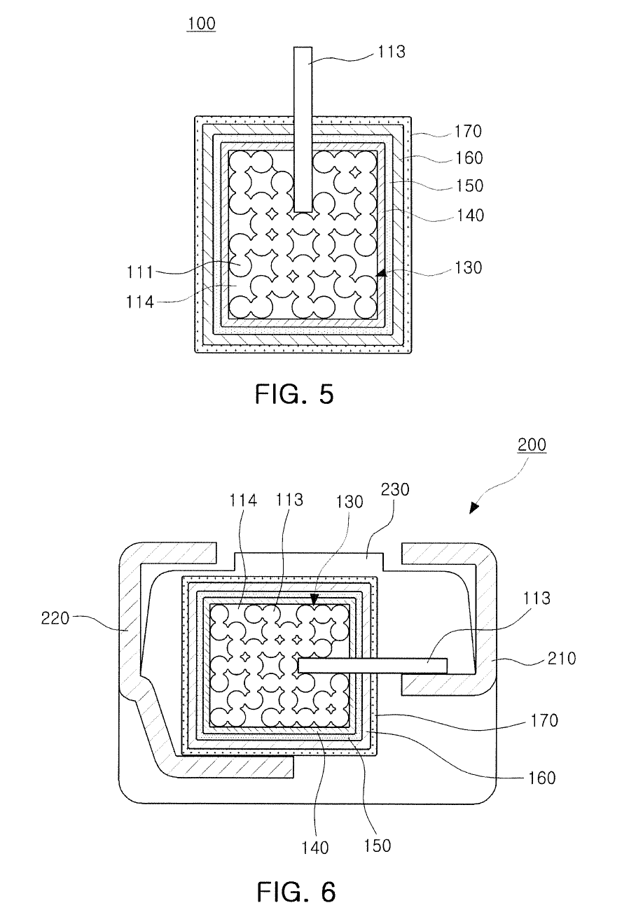

FIG. 4 is a perspective view of a solid electrolyte capacitor, according to an exemplary embodiment, and FIG. 5 is a cross-sectional view of the solid electrolyte capacitor taken along line A-A′ of FIG. 4.

Referring to FIGS. 4 and 5, the solid electrolyte capacitor 100, according to the exemplary embodiment, may include a dielectric oxide film layer 140, a solid electrolyte layer 150, and cathode reinforcement layers 160 and 170 composed of a carbon layer 160 and a cathode layer 170 sequentially layered on an outer surface of the sintered body 130.

The dielectric oxide film layer 140 may be formed by growing tantalum oxide (Ta₂O₅), which is an oxide film, on the outer surface of the sintered body 130 by a formation method using an electrochemical reaction.

The solid electrolyte layer 150 may be formed on a surface of the dielectric oxide film layer 140. The solid electrolyte layer 150 may contain at least one of a conductive polymer and manganese dioxide (MnO₂).

In a case in which the solid electrolyte layer 150 is formed of the conductive polymer, the solid electrolyte layer 150 may be formed on the surface of the dielectric oxide film layer 140 by a chemical polymerization method or electro-polymerization method. For a conductive polymer material, a polymer material having conductivity may be used without any particular limitation. For example, the conductive polymer material may contain polypyrrole, polythiophene, polyaniline, or the like.

Ina case in which the solid electrolyte layer 150 is formed of manganese dioxide (MnO₂), conductive manganese dioxide may be formed on the surface of the dielectric oxide film layer 140 by dipping the sintered body 130, on the surface of which the dielectric oxide film layer 140 is formed, in a manganese aqueous solution such as a manganese nitrate aqueous solution, and pyrolyzing the manganese aqueous solution.

The cathode reinforcement layers 160 and 170 may be formed on the solid electrolyte layer 150. The cathode reinforcement layers 160 and 170 may include the carbon layer 160 and the cathode layer 170. The carbon layer 160 may be formed of a carbon paste. That is, the carbon layer 160 may be formed by applying the carbon paste onto the solid electrolyte layer 150, wherein the carbon paste is dispersed in water or an organic solvent in a state in which conductive carbon powder such as natural graphite or carbon black is mixed with a binder, a dispersant, or the like.

The cathode layer 170 containing a conductive metal may be disposed on the carbon layer 160 in order to improve electric connectivity with a cathode lead frame 220 (see FIG. 6), wherein the conductive metal contained in the cathode layer 170 maybe silver (Ag).

FIG. 6 is a cross-sectional view of a solid electrolyte capacitor 200, according to another exemplary embodiment.

Referring to FIG. 6, the solid electrolyte capacitor 200, according to another exemplary embodiment, may further include an anode lead frame 210 connected to an anode lead wire 113 and a cathode lead frame 220 connected to cathode reinforcement layers 160 and 170 formed on an outer surface of the sintered body 130. Further, the solid electrolyte capacitor 200 may further include a molding part 230 enclosing the sintered body 130, the anode lead wire 113, the anode lead frame 210, and the cathode lead frame 220. In this case, portions of the anode lead frame 210 and the cathode lead frame 220 may be exposed to the outside of the molding part 230.

The anode lead frame 210 and the cathode lead frame 220 may be connected to external power (not illustrated) to allow current to pass through the anode lead wire 113 and the cathode reinforcement layers 160 and 170. That is, the anode lead frame 210 and the cathode lead frame 220 may be exposed to the outside of the molding part 230 to serve as connection terminals for electric connections with another electronic product.

The molding part 230 may serve to protect the solid electrolyte capacitor 200 from external factors and be mainly formed of an epoxy or a silica based epoxy molding compound (EMC). However, the molding part 230 is not limited thereto.

### Method of Manufacturing Solid Electrolyte Capacitor

Hereinafter, a manufacturing method of the solid electrolyte capacitor 100, according to the exemplary embodiment, will be described with reference to the accompanying drawings. However, in order to avoid an overlapping description, a description of the same content as described above will be omitted.

Referring to FIGS. 1 through 3, the manufacturing method of the solid electrolyte capacitor 100, according to the exemplary embodiment, may include forming a molded body 110 by stirring and molding metal powder 111 and an inorganic additive 112; forming a sintered body 130 by sintering the molded body 110; and forming air gaps 114 by removing the inorganic additive 112 from the sintered body 130. The manufacturing method may further include, after the forming of the molded body 110, forming a compressed body 120 by compressing the molded body 110. Thereafter, the sintered body 130 may be formed by sintering the compressed body 120.

Referring to FIG. 1, mixed powder may be formed by stirring and mixing the metal powder 111 and the inorganic additive 112 as described above using a stirrer, and the molded body 110 may be formed by molding the mixed powder into a suitable shape. Generally, the molded body 110 is formed in a rectangular parallelepiped shape, but the shape of the molded body 110 is not limited thereto. Then, the anode lead wire 113 may be inserted into one surface of the molded body. Next, referring to FIG. 2, the compressed body 120 may be formed by compressing the molded body 110.

Thereafter, referring to FIG. 3, the sintered body 130 may be formed by sintering the compressed body 120 under high temperature and vibration conditions. Then, in order to remove the inorganic additive 112 contained in the sintered body 130, the sintered body 130 may be subjected to chemical treatment. The chemical treatment may be performed by dipping the sintered body 130 in a solution capable of dissolving the inorganic additive 112. In this case, it may be preferable to select a solution that may dissolve only the inorganic additive 112 but does not have an influence on other materials included in or configuring the sintered body 130.

When the inorganic additive 112 contained in the sintered body 130 is silica powder, the solution used to dissolve the inorganic additive 112 may contain ammonium fluoride. Ammonium fluoride, a silica dissolving agent, may selectively remove the silica powder from the sintered body 130.

The air gaps 114 may be formed in the sintered body 130 by removing the inorganic additive 112 in the sintered body 130 as described above.

Next, referring to FIG. 5, after removing the inorganic additive 112 from the sintered body 130, the dielectric oxide film layer 140, a solid electrolyte layer 150 having a negative polarity, and the cathode reinforcement layers 160 and 170 may be sequentially formed on a surface of the sintered body 130.

The dielectric oxide film layer 140 may be formed by growing tantalum oxide (Ta₂O₅), which is an oxide film, on the outer surface of the sintered body 130 by a formation method using an electrochemical reaction.

Next, the solid electrolyte layer 150 may be formed on a surface of the dielectric oxide film layer 140. The solid electrolyte layer 150 may contain at least one of a conductive polymer and manganese dioxide (MnO₂).

In a case in which the solid electrolyte layer 150 is formed of a conductive polymer, the solid electrolyte layer 150 may be formed on the surface of the dielectric oxide film layer 140 by a chemical polymerization method or electro-polymerization method. For the conductive polymer material, a polymer material having conductivity may be used without any particular limitation. For example, the conductive polymer material may contain polypyrrole, polythiophene, polyaniline, or the like.

Ina case in which the solid electrolyte layer 150 is formed of manganese dioxide (MnO₂), conductive manganese dioxide may be formed on the surface of the dielectric oxide film layer 140 by dipping the sintered body 130 (on the surface of which the dielectric oxide film layer 140 is formed) in a manganese aqueous solution such as a manganese nitrate aqueous solution, and pyrolyzing the manganese aqueous solution.

Next, the cathode reinforcement layers 160 and 170 may be formed on the solid electrolyte layer 150. The cathode reinforcement layers 160 and 170 may include a carbon layer 160 and a cathode layer 170. The carbon layer 160 may be formed of a carbon paste. That is, the carbon layer 160 may be formed by applying the carbon paste onto the solid electrolyte layer 150, wherein the carbon paste is dispersed in water or an organic solvent in a state in which conductive carbon powder such as natural graphite or carbon black is mixed with a binder, a dispersant, or the like.

The cathode layer 170 containing a conductive metal may be disposed on the carbon layer 160 in order to improve electric connectivity with a cathode lead frame 220 (see FIG. 6), wherein the conductive metal contained in the cathode layer 170 maybe silver (Ag).

FIG. 6 illustrates the solid electrolyte capacitor 200 further including an anode lead frame 210, a cathode lead frame 220, and a molding part 230.

Referring to FIG. 6, the solid electrolyte capacitor 100 includes the sintered body onto which the above-mentioned cathode layer 170 is applied, and the anode lead wire 113. Additionally, the anode lead frame 210 may be formed to contact the anode lead wire 113, and the cathode lead frame 220 may be formed to contact the cathode reinforcement layers 160 and 170 formed on the outer surface of the sintered body 130. The anode lead frame 210 and the cathode lead frame 220 may be formed of a conductive metal such as a nickel/iron alloy, or the like.

The anode lead frame 210 and the cathode lead frame 220 may be disposed in parallel with each other, while being spaced apart from each other. A lower surface of each of the anode lead frame 210 and the cathode lead frame 220 maybe exposed to a lower surface of the molding part 230, and thus the anode lead frame 210 and the cathode lead frame 220 may be used as connection terminals for electric connection with another electronic product.

The anode lead frame 210 may be formed to contact the anode lead wire 113. Contact portions between the anode lead frame 210 and the anode lead wire 113 may be bonded by electric welding or using a conductive adhesive.

The cathode lead frame 220 may be formed to be flat in order to increase bonding strength with the cathode reinforcement layers 160 and 170, and thus an area of a bonded portion between the cathode lead frame 220 and the cathode reinforcement layers 160 and 170 may be increased. An adhesive layer (not illustrated) may be formed on an upper surface of the cathode lead frame 220 using a conductive adhesive, or the like, and the cathode reinforcement layers 160 and 170 may be mounted thereon so that one surface thereof contacts the adhesive layer. The conductive adhesive may contain an epoxy based thermosetting resin and a conductive material, wherein the conductive material may contain at least one of silver (Ag), gold (Au), palladium (Pd), nickel (Ni), and copper (Cu).

Next, the molding part 230 may be formed to enclose the sintered body 130 on which the cathode reinforcement layers 160 and 170, the anode lead wire 113, the anode lead frame 210, and the cathode lead frame 220 are applied/mounted. The molding part 230 may be formed by transfer molding a resin such as an epoxy molding compound (EMC). In this case, the molding part 230 may be formed to partially expose the anode lead frame 210 and the cathode lead frame 220.

As set forth above, according to exemplary embodiments, the solid electrolyte capacitor having improved impregnation properties may be obtained, and thus high capacitance and excellent equivalent series resistance (ESR) characteristics may be implemented.

While exemplary embodiments have been shown and described above, it will be apparent to those skilled in the art that modifications and variations could be made without departing from the scope of the present invention as defined by the appended claims.

What is claimed is:

1. A solid electrolyte capacitor comprising:
a sintered body including a molded body containing a mixture of metal powder and an inorganic additive; and
an anode lead wire disposed to be partially inserted into the sintered body,
wherein the sintered body includes an air gap where at least a portion of the inorganic additive is removed.

2. The solid electrolyte capacitor of claim 1, wherein the inorganic additive is silica powder.

3. The solid electrolyte capacitor of claim 1, wherein the inorganic additive has a particle size of 1 μm to 10 μm.

4. The solid electrolyte capacitor of claim 1, wherein a shape of the air gap corresponds to a shape of the inorganic additive removed from the sintered body.

5. The solid electrolyte capacitor of claim 1, wherein the metal powder includes at least one selected from the group consisting of tantalum (Ta), aluminum (Al), niobium (Nb), vanadium (V), titanium (Ti), and zirconium (Zr).

6. The solid electrolyte capacitor of claim 1, further comprising:
a dielectric oxide film layer, a solid electrolyte layer having a negative polarity, and a cathode reinforcement layer which are sequentially layered on a surface of the sintered body.

7. The solid electrolyte capacitor of claim 6, wherein the solid electrolyte layer is formed of at least one selected from the group consisting of manganese dioxide (MnO₂) and a conductive polymer.

8. The solid electrolyte capacitor of claim 6, wherein the cathode reinforcement layer is provided by sequentially applying carbon and silver (Ag).

9. The solid electrolyte capacitor of claim 1, wherein the sintered body includes an air gap where all of the inorganic additive is removed.

10. A method of manufacturing a solid electrolyte capacitor, the method comprising:
forming a molded body by stirring metal powder and an inorganic additive and molding the same;
forming a sintered body by sintering the molded body; and
forming an air gap by removing the inorganic additive from the sintered body after sintering.

11. The method of claim 10, wherein the inorganic additive is silica powder.

12. The method of claim 10, wherein the inorganic additive has a particle size of 1 μm to 10 μm.

13. The method of claim 10, wherein the inorganic additive is removed by dipping the sintered body in a solution containing ammonium fluoride.

14. The method of claim 10, wherein the metal powder includes at least one selected from the group consisting of tantalum (Ta), aluminum (Al), niobium (Nb), vanadium (V), titanium (Ti), and zirconium (Zr).

15. The method of claim 10, wherein after removing the inorganic additive from the sintered body, a dielectric oxide film layer, a solid electrolyte layer having a negative polarity, and a cathode reinforcement layer are sequentially formed on a surface of the sintered body.

16. The method of claim 15, wherein the solid electrolyte layer is formed of at least one selected from the group consisting of manganese dioxide (MnO₂) and a conductive polymer.

17. The method of claim 15, wherein the cathode reinforcement layer is formed by sequentially applying carbon and silver (Ag).
